(19) United States
(12) Patent Application Publication
(10) Pub. No.: US 2008/0115546 A1
(43) Pub. Date: May 22, 2008

(54) Pushbutton lock

(76) Inventor: Jeffery Hu, Taichung (TW)

Correspondence Address: BRUCE H. TROXELL;SUITE 1404, 5205 LEESBURG PIKE, FALLS CHURCH, VA, 22041, US

(21) Appl. No.: 11/603,040

(22) Filed: Nov. 22, 2006

(51) Int. Cl. E05B 13/10

(52) U.S. Cl. 70/214

(57) ABSTRACT

A pushbutton lock coupling with a handle lock includes an outer handle assembly, an outer lock case, a first control assembly, a second control assembly, a bolt assembly, a cam assembly, an inner lock case and an inner handle assembly. The first control assembly and the second control assembly form a chain movement through the cam assembly. After unlocking the door can be directly opened through an outer handle. The pushbutton lock further has lock blades with alterable arrangement to reset the number. Moreover, a clear pushbutton is provided to clear and correct mistaken depression of the pushbuttons. Thus use and operation of the pushbutton lock are more convenient.

### BACKGROUND OF THE INVENTION

1. Field of the Invention

The present invention relates to a pushbutton lock and particularly to a pushbutton lock coupling with a handle lock to facilitate operation.

2. Description of the Prior Art

Referring to FIG. 11, a conventional pushbutton lock 91 is installed on a door 90. To do unlocking, first the pushbutton lock 91 has to be unlocked by turning a rotary knob 911 to retract a dead bolt 912, then a handle lock 92 is turned to retract a latch bolt 921 to control a switch of the door 90 to allow the door to be opened or closed. Reference of such a pushbutton lock 91 can be found in Taiwan patent publication No. 219085.

### SUMMARY OF THE INVENTION

In view of the conventional pushbutton lock set forth above has to couple with a handle lock when in use, not only installation cost is higher, daily opening and closing of the door involve an additional process and is not convenient, the present invention aims to provide a pushbutton lock that is coupled with a handle lock to make use and operation more convenient. The pushbutton lock according to the invention includes an outer handle assembly, an outer lock case, a first control assembly, a second control assembly, a bolt assembly, a cam assembly, an inner lock case and an inner handle assembly. The first control assembly and the second control assembly form a chain movement through the cam assembly. After unlocking the door can be directly opened through an outer handle. The invention further has lock blades that may be altered to reset the number. Moreover, a clear pushbutton is provided to clear and correct mistaken depression of the pushbuttons. Thus use and operation of the pushbutton lock are more convenient.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is a fragmentary sectional view of the invention.

FIG. 4-a is a schematic view of an embodiment of the lock blade of the invention.

FIG. 4-b is a schematic view of another embodiment of the lock blade of the invention.

FIG. 5 is a schematic view of the invention showing operating condition-1.

FIG. 6 is a schematic view of the invention showing operating condition-2.

FIG. 7 is a schematic view of the invention showing operating condition-3.

FIG. 8 is a schematic view of the invention showing operating condition-4.

FIG. 9 is a schematic view of the invention showing operating condition-5.

FIG. 10 is a schematic view of the invention showing operating condition-6.

FIG. 11 is a schematic view of a conventional pushbutton lock.

### DESCRIPTION OF THE PREFERRED EMBODIMENT

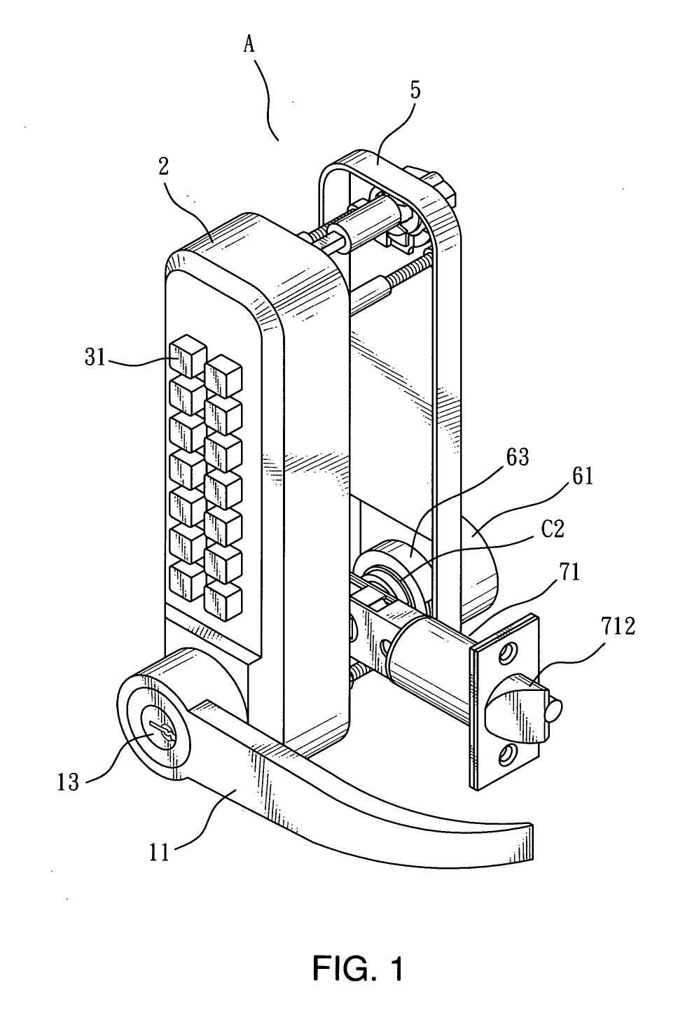

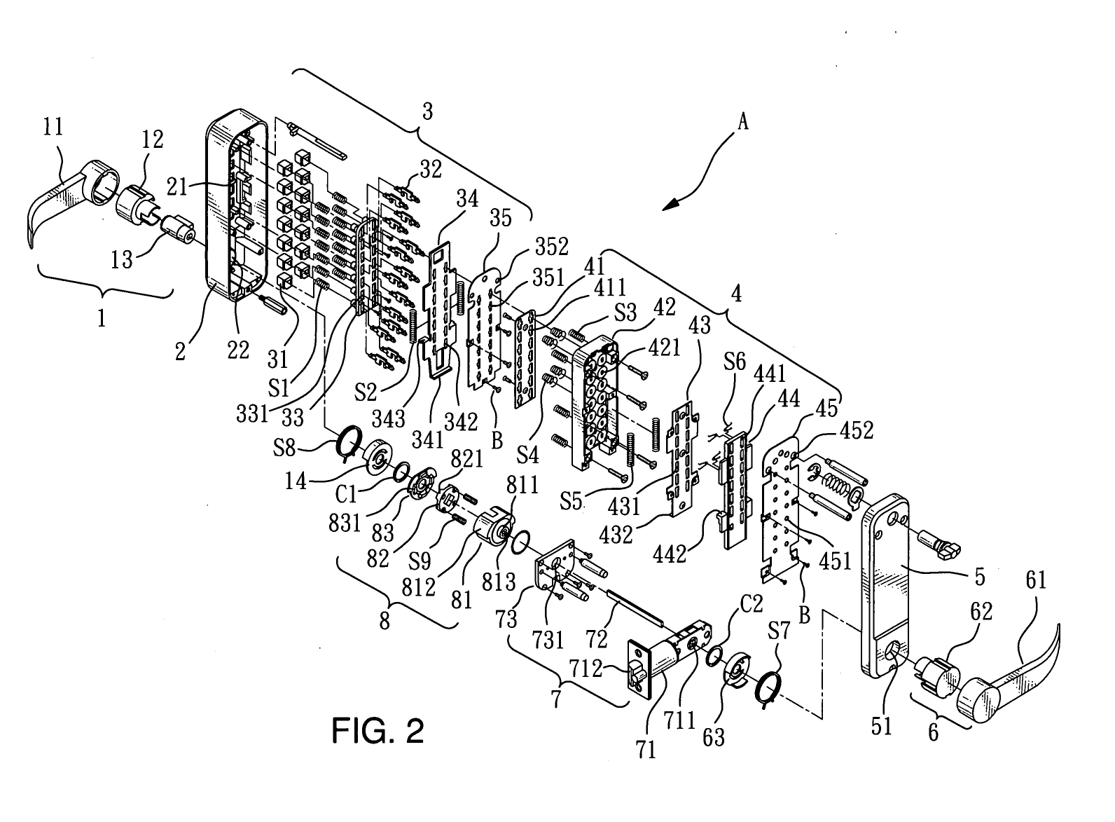

Referring to FIGS. 1 and 2, the pushbutton lock A according to the invention includes an outer handle assembly 1, an outer lock case 2, a first control assembly 3, a second control assembly 4, an inner lock case 5, an inner handle assembly 6, a bolt assembly 7, and a cam assembly 8.

The outer handle assembly 1 includes an outer handle 11, an outer hub 12, a lock 13, an outer torsional spring S8 and a first inner coupling pad 14 that are installed on the outer lock case 2 by latching a first clip ring C1.

The outer lock case 2 has a plurality of pushbutton ports 21 and an outer axle hole 22.

The first control assembly 3 includes:

a plurality of pushbuttons 31 installed in the pushbutton ports 21. Each of the pushbuttons 31 is pushed outwards by a first spring S1 in normal conditions, and assigned with a code (including numeral codes 0, 1, . . . , 9, and character codes X, Y, Z, C);

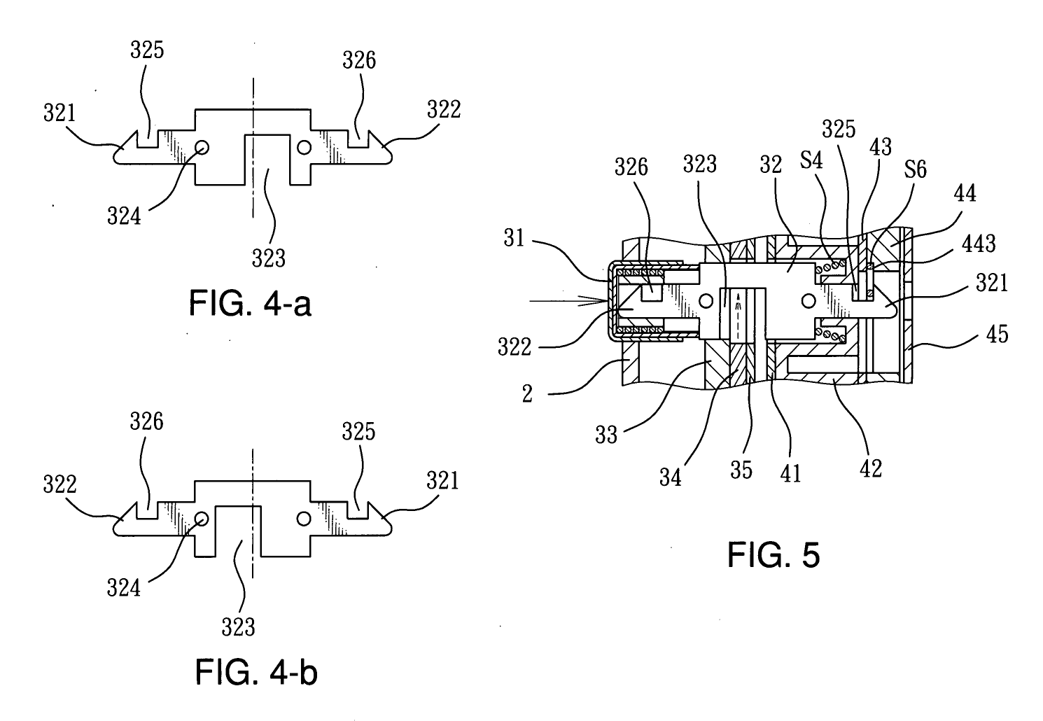

a plurality of lock blades 32 (referring to FIG. 4-a) each having a first hook end 321, a second hook end 322, a first notch 325 and a second notch 326 on two ends. There also is a middle notch 323 between the first hook end 321 and the second hook end 322 that is closer to the second hook end 322. Each lock blade also has two retaining bulged spots 324 on two sides of the middle notch 323;

a first anchor plate 33 which has a plurality of first insertion slots 331 corresponding to the pushbuttons 31 to be inserted by the lock blades 32;

a first sliding plate 34 which has a plurality of second insertion slots 342 corresponding to the pushbuttons 31 to be inserted by the lock blades 32, a first lug 343 on each of two sides to be pushed by a second spring S2 to drive the first sliding plate 34 downwards in normal conditions, and a first lower bucking portion 341 on a lower edge; and

a first covering plate 35 which has a plurality of third insertion slots 351 corresponding to the pushbuttons 31 to be inserted by the lock blades 32, and a plurality of fastening holes 352 to be fastened by corresponding bolts B to finish assembly of the first control assembly 3.

The second control assembly 4 includes:

a second anchor plate 41 which has a plurality of fourth insertion slots 411 corresponding to the pushbuttons 31 to be inserted by the lock blades 32;

a base dock 42 which has a plurality of insertion slot seats 421 to be inserted by the lock blades 32 and hold a fourth spring S4, and a holding trough (not shown in the drawings) at four corners to hold a third spring S3 to facilitate separation of the first control assembly 3 and the second control assembly 4 after assembly;

a second sliding plate 43 which has a plurality of fifth insertion slots 431 corresponding to the pushbuttons 31 to be inserted by the lock blades 32, and a second lower bucking portion 432 on a lower end;

a third sliding plate 44 which has a plurality of sixth insertion slots 441 corresponding to the pushbuttons 31 to be inserted by the lock blades 32, a holding trough 443 on one side of each sixth insertion slot 441 to hold a sixth spring S6 (referring to FIG. 5), and a second lug 442 on each of two sides to hold a fifth spring S5 to drive the third sliding plate 44 downwards in the normal conditions; and

a second covering plate 45 which has a plurality of apertures 451 corresponding to the pushbuttons 31, and a plurality of fastening holes 452 to be fastened by corresponding bolts B to finish assembly of the second control assembly 4.

The inner lock case 5 is corresponding to the outer lock case 2 and installed on an inner side of the door, and has an inner axle hole 51.

The inner handle assembly 6 includes an inner handle 61, an inner hub 62, an inner torsional spring S7 and a second inner coupling pad 63 that are installed on the inner lock case 5 by latching a second clip ring C2.

The bolt assembly 7 has a bolt seat 71 with an axle opening 711 formed thereon to be run through by a linkage bar 72 to couple with a third anchor plate 73 on one side.

The cam assembly 8 has a protrusive portion 811 on one side and an axle hole 813 formed thereon. The protrusive portion 811 is wedged in an axle hole 731 of the third anchor plate 73. The cam 81 further has a symmetrical protrusive rim 812 on the periphery, and has the interior holding at least in this order a ninth spring S9 and an inner rotary tray 82, and is covered by an outer rotary tray 83 which has a plurality of outer ratchet teeth 831 engageable with inner ratchet teeth 821 formed on the inner rotary tray 82.

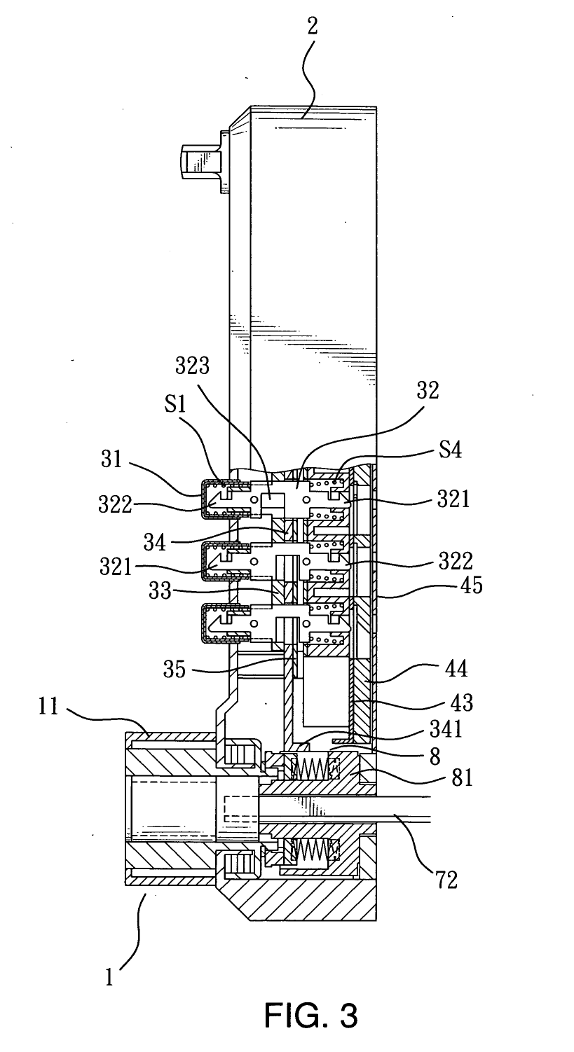

After assembly, referring to FIG. 3, changing of the unlocking push number is done mainly by altering the insertion direction of the first hook end 321 and the second hook end 322 of the lock blades 32. Namely the lock blades 32 may be installed in two ways, one for an opening condition (referring to FIG. 4-a), another for a closing condition (referring to FIG. 4-b). In the closing condition, the middle notch 323 of the lock blade 32 latches and stops the first sliding plate 34 from sliding, thus its first lower bucking portion 341 presses the cam 81 to prohibit it from turning, and the outer handle 11 also cannot be turned to become a locking condition.

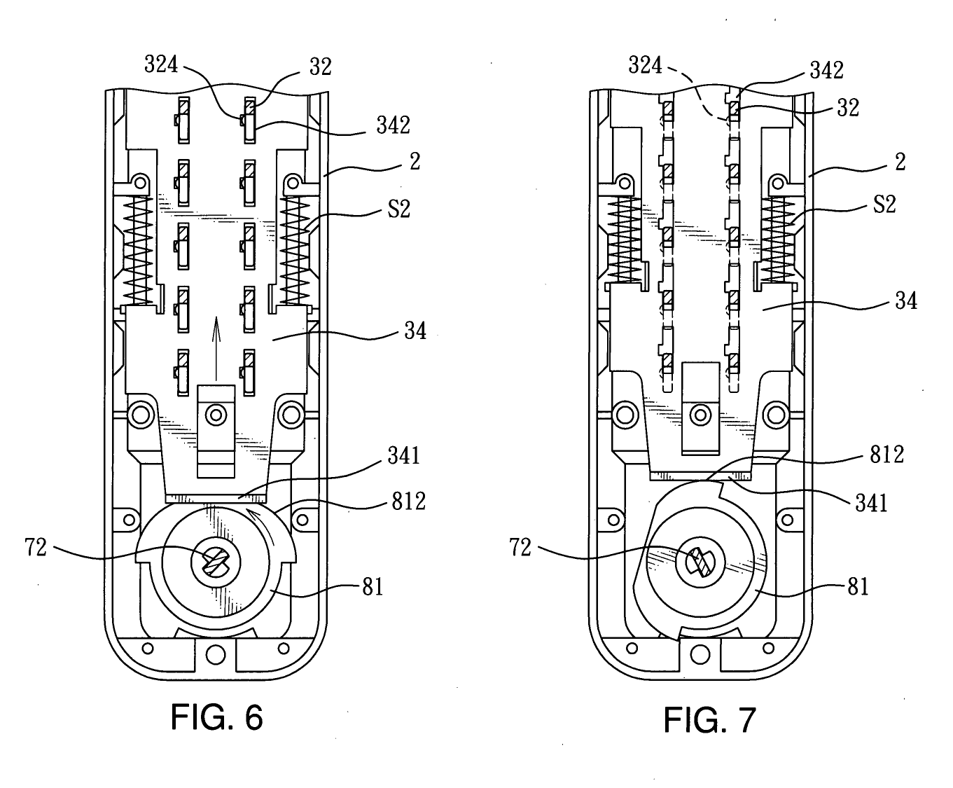

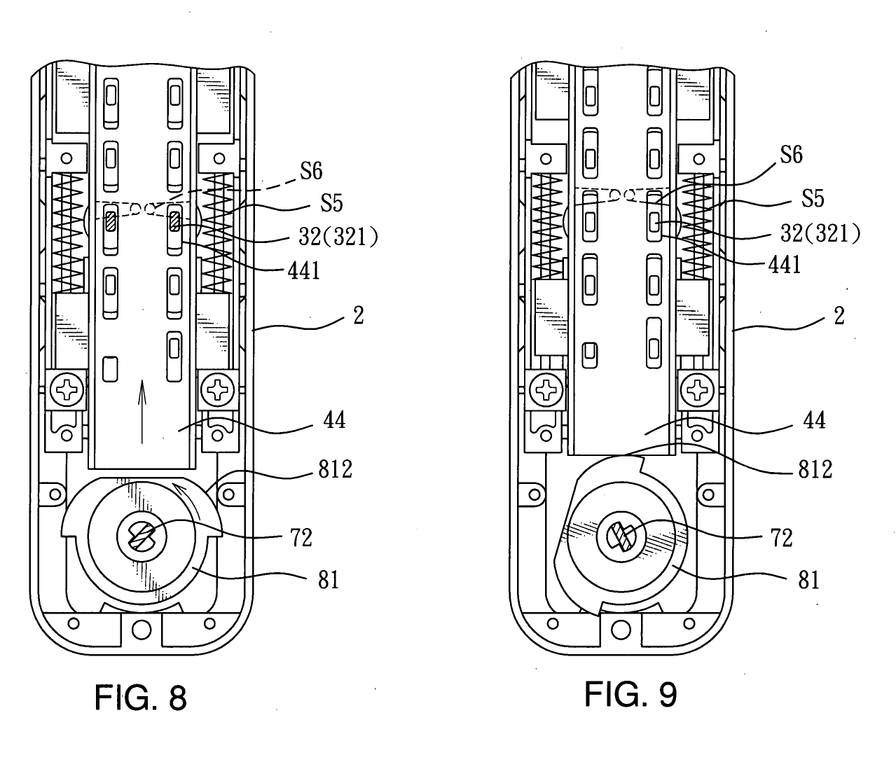

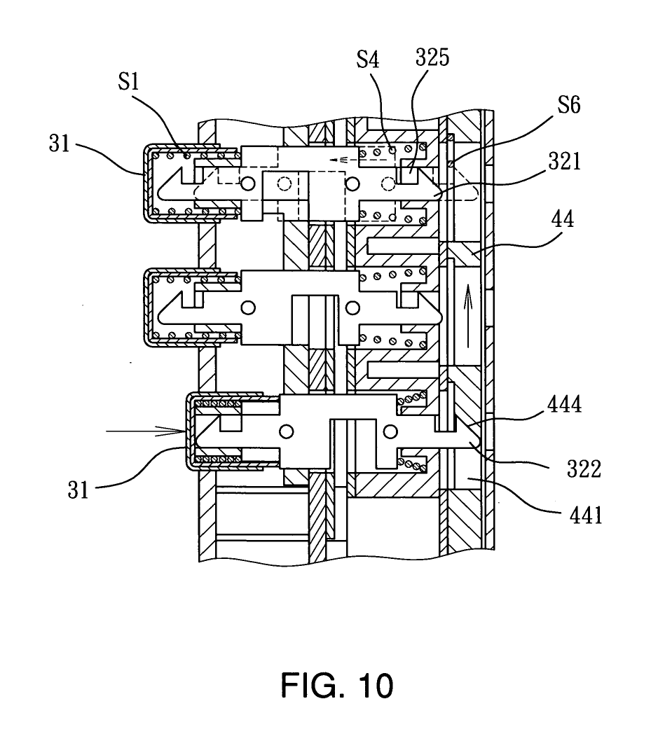

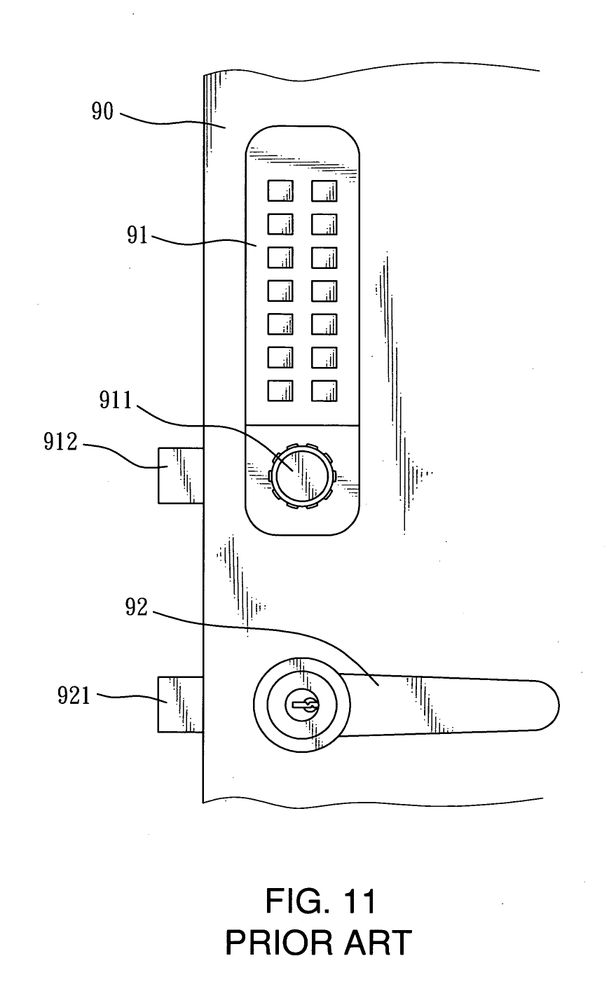

To do unlocking, first depress the pushbuttons 31 according to a preset number, the first hook end 321 of the corresponding lock blades 32 is moved backwards and engaged with the corresponding sixth spring S6 of the third sliding plate 44 (referring to FIG. 5). The first sliding plate 34 is no longer being harnessed. Hence turning the outer handle 11 can drive the cam 81. The protrusive rim 812 pushes the first sliding plate 34 upwards (referring to FIGS. 6 and 7), and the linkage bar 72 is synchronously driven to retract the latch bolt 712 of the bolt seat 71 rearwards (not shown in the drawings), then the unlocking condition is accomplished. While the cam 81 is turning, the protrusive portion 812 also pushes the third sliding plate 44 upwards (referring to FIGS. 8 and 9), the first notch 325 of the first hook end 321 escapes the latching of the sixth spring S6 (referring to FIG. 10), hence the lock blade 32 receives the elastic returning force of the fourth spring S4 to drive the pushbutton 31 to its original position through the elastic force of the first spring S1.

In the event that a mistaken number is entered by users, one of pushbuttons 31 marked with “C” can be depressed to clear the situation to redo entering operation for the correct number. When the pushbutton 31 marked with “C” is depressed, as the corresponding third sliding plate 44 has a sloped boss 444 on the sixth insertion plate 441 (referring to FIG. 10), the second hook end 322 of the depressed pushbutton 31 marked with “C” pushes the sloped boss 444 to move the third sliding plate 44 upwards to force the lock blade 32 that originally latched on the sixth spring S6 to escape. Thus a desired number can be entered through the pushbuttons again.

In short, the pushbutton lock of the invention allows the outer handle to directly open the door after unlocking. The arrangement of the lock blades can be changed to alter the setting number. By depressing the clear pushbutton mistaken entering number can be cleared and corrected. It is more convenient to use, and offers a significant improvement over the conventional techniques.

I claim:

1. A pushbutton lock comprising an outer handle assembly, an outer lock case, a first control assembly, a second control assembly, an inner lock case, an inner handle assembly, a bolt assembly and a cam assembly; wherein:
the outer handle assembly includes an outer handle, an outer hub, a lock, an outer torsional spring and a first inner coupling pad that are installed on the outer lock case;
the outer lock case has a plurality of pushbutton ports and an outer axle hole;
the first control assembly includes:
a plurality of pushbuttons installed in the pushbutton ports, each of the pushbuttons being pressed outwards by a first spring in normal conditions and assigned with a code;
a plurality of lock blades each having a first hook end, a second hook end, a first notch and a second notch on two ends, the first hook end and the second hook end being interposed by a middle notch;
a first anchor plate which has a plurality of first insertion slots corresponding to the pushbuttons to be inserted by the lock blades;
a first sliding plate which has a plurality of second insertion slots corresponding to the pushbuttons to be inserted by the lock blades, a first lug on each of two sides to be pushed by a second spring to drive the first sliding plate downwards in the normal conditions; and
a first covering plate which has a plurality of third insertion slots corresponding to the pushbuttons to be inserted by the lock blades and a plurality of fastening holes to be fastened by corresponding first bolts to finish assembly of the first control assembly;
the second control assembly includes:
a second anchor plate which has a plurality of fourth insertion slots corresponding to the pushbuttons to be inserted by the lock blades;
a base dock which has a plurality of insertion slot seats to be inserted by the lock blades and to hold a fourth spring;
a second sliding plate which has a plurality of fifth insertion slots corresponding to the pushbuttons to be inserted by the lock blades and a second lower bucking portion on a lower end;
a third sliding plate which has a plurality of sixth insertion slots corresponding to the pushbuttons to be inserted by the lock blades, a holding trough on one side of the sixth insertion slot to hold a sixth spring, and a second lug on each of two sides thereof to hold a fifth spring to drive the third sliding plate downwards in the normal conditions; and
a second covering plate which has a plurality of apertures corresponding to the pushbuttons and a plurality of fastening holes to be fastened by corresponding second bolts to finish assembly of the second control assembly;
the inner lock case is corresponding to the outer lock case and installed on an inner side of a door, and has an inner axle hole;
the inner handle assembly includes an inner handle, an inner hub, an inner torsional spring and a second inner coupling pad that are installed on the inner lock case;
the bolt assembly has a bolt seat with an axle opening formed thereon to be run through by a linkage bar to couple with a third anchor plate on one side;
the cam assembly has a protrusive portion on one side and an axle opening on the protrusive portion, the protrusive portion being wedged in an axle hole of the third anchor plate, the cam further having a symmetrical protrusive rim on the periphery.

2. The pushbutton lock of claim 1, wherein the middle notch of the lock blade is close to the second hook end.

3. The pushbutton lock of claim 1, wherein the first sliding plate has a first lower bucking portion on a lower edge.

4. The pushbutton lock of claim 1, wherein the cam assembly has an interior to hold at least in this order a ninth spring and an inner rotary tray, and is covered by an outer rotary tray which has a plurality of outer ratchet teeth engageable with inner ratchet teeth formed on the inner rotary tray.
